(19) United States
(12) Patent Application Publication
(10) Pub. No.: US 2020/0154800 A1
(43) Pub. Date: May 21, 2020

(54) ARRANGEMENT APPLIED TO HUMIDIFIER AND PROTECTION MASK

(71) Applicant: Doris Hexsel, Porto Alegre (BR)

(72) Inventor: Doris Hexsel, Porto Alegre (BR)

(21) Appl. No.: 16/773,013

(22) Filed: Jan. 27, 2020

Related U.S. Application Data
(63) Continuation of application No. PCT/BR2018/050237, filed on Jul. 12, 2018.

(30) Foreign Application Priority Data
Jul. 27, 2017 (BR) 2020170161701

(51) Int. Cl. A41D 13/11; A62B 18/02; A62B 23/02

(52) U.S. Cl. CPC A41D 13/1138; A62B 23/025; A62B 18/02

(57) ABSTRACT

In general, this utility model belongs to the technological sector of face masks and more specifically refers to a new arrangement applied to a humidifier and protection mask. The accessory developed is an innovative alternative to the state of the art, proposing practical, versatile and low-cost face masks, disposable or not, capable of humidifying inhaled air in a simple and economical way, without the use of external energy. Accordingly, the mask has a filter for particles, composed of a material that retains fluids and can be replenished simply by the user himself, preferably with water or other fluids, with spaces that allow the entry of air taken in, so that inhaled air containing oxygen only enters into the mask through the humidifier filter. Masks can be disposable or not, and reusable ones are made of washable materials. Due to the fact that the humidifier filter material can be replaceable for reasons of hygiene, it can be removed from the base or body of the mask and replaced for a new one.

### TECHNOLOGY SECTOR OF THE UTILITY MODEL

In general this utility model belongs to the technological sector of face masks and more specifically refers to a new arrangement applied to a protection mask with humidifier function of the airways.

### KNOWN STATE OF THE ART

The dry climate, characterized by low relative air humidity, is common at certain times of the year and also indoor areas that make the use of air con, and this same equipment reduces the humidity of the environment. Under these conditions, reactions such as irritation in the eyes, throat and nose are commonly reported symptoms, and dry cough and bleeding may also occur due to the drying up of the mucous membranes of the respiratory tract. Dust, inhalable fine particles and other pollutants are suspended in the air due to the low dispersion of this type of particle in dry climates. Airways are the most sensitive parts of the body to these climate conditions, and discomfort is even greater for people who already have respiratory diseases such as asthma, allergic rhinitis or chronic bronchitis or respiratory tract infections.

It is known that the dryness of the ambient air can be improved by different techniques, such as water vaporizations. These can be obtained through boiling water or using various nebulization and/or humidification apparatus. However, considering long journeys on aircraft and work shifts in companies with dry environments, these methods are little used due to the lack of simple equipment that is low cost, easy to handle and transport, and that humidifies the air inhaled by individuals efficiently.

In the presence of smoke due to the burning of materials or fuels without adequate exhaustion in the environment, as in the occurrence of a fire, the concentration of particulate matter suspended in the air is high, and may contain organic compounds, sulfates, nitrates, among others, that are harmful to living beings. This type of situation also requires the use of special equipment to protect an individual's airways, i.e., mucous membranes of the nose, mouth and the entire respiratory tract, including trachea, bronchi, lungs. For example, the protection masks used by firefighters in fires are generally made of materials that filter particles suspended in the air, providing protection and safety to users.

Therefore, it is clear that a simple solution to the problems described above is the use of face masks, made of materials capable of filtering particles suspended in the air and that also humidify the air inside thereof. One of the drawbacks associated with the current state of the art is the fact that commercial respiratory facial masks do not present the functionalities associated with simple encasement on the face, comfortable to use and at an affordable price. The lack of such an accessory causes many people to use a damp towel on their faces to humidify the air in dry environments or to prevent the entry of particles that are damaging to health, this not being a very practical solution, since the towel has to be held over one's face.

From this starting block, the emergence of humidifier masks has expanded with the aim of providing alternatives that best fit the user's face and also allow greater freedom for same. However, these types of masks are usually complex, are expensive to purchase, require connections with energy sources or, moreover, do not have functional characteristics that allow the air expelled by the users' lungs to be released in a controlled manner.

That said, it turns out that there are several facial masks described in patent documents. Patent of invention No. BR 10 2015 030779 9, entitled “Moistened Mask for Facial Protection” reveals a facial protective mask with internal moistened filter that protects the user in emergency situations such as fires, accidents, explosions and the like, protecting the respiratory system and avoiding the inhalation of toxic components. The mask is endowed with filters formed by handkerchiefs, towels and water-moistened material as a diluent agent of the composition that should contain moisturizing, antimicrobial, antibacterial, antifungal, anticorrosive agents, moisture controllers, preservatives and stabilizers, all preferably nontoxic and antiallergic. However, the moistened filter, composed of several substances, in addition to increasing the manufacturing cost thereof, makes it uncomfortable to use after a long period, given that no practical and versatile solution has been proposed. Additionally, the mask described is designed for exclusive use in fires, so after drying the filter should be discarded.

North American patent document No. U.S. Pat. No. 4,941,467, entitled “Humidification Face Mask” describes a facial mask endowed with a humidification pad. The mask further features perforations in its outer layer, however, its humidification pad located inside the mask does not have perforations. The mask is designed with a recovery pad to absorb water droplets due to the fact that there are no suitable spaces for vapor to escape. In contrast, the mask proposed in this utility model features movable openings or valves that allow the outlet of expired air out of the mask and also prevents the passage of air inhaled into the mask.

Additionally, it is worth mentioning the North American patent document No. U.S. Pat. No. 5,433,192 entitled “Breathing Mask Having A Cellulose Heat And Moisture Exchanger Formed Therein”. The document in question describes a breathing mask made of cellulose material, capable of recovering the heat and moisture contained in the air exhaled by breathing. The mask has major advantages of being used at very low temperatures, especially sub-zero. In contrast, the mask proposed in this model offers humidification of air inhaled from the environment and the elimination of carbon dioxide out of the mask, avoiding the re-inhalation thereof, at any temperature, whether high or low.

Accordingly, based on all the drawbacks existing in the humidifier face masks currently used and described in the state of the art, there is a visible gap in the creation of a mask that has the features of humidifying the air inside, so that the user inhales humidified air, at the same time, filtering the particles suspended in the air and that is also anatomically configured, enabling the use and replenishment of the humidifier fluid, namely water, for a long period, in a simple and low cost way. Put otherwise, there is no humidifier face mask known on the market that is practical and comfortable to use.

### NOVELTIES AND OBJECTIVES OF THE UTILITY MODEL

In order to provide substantial improvements and solutions to the drawbacks pointed out in the state of the art, this utility model proposes a humidifier face mask of individual use and preferably disposable, endowed with a humidifier filter to be soaked with water by the user him/herself, through which the inspired air will pass, and containing mobile openings or valves that allow the outlet of expired air, which contains CO₂ and is unsuitable for re-inhaling.

The solution developed can be used in several environments, since it is designed in an arrangement that makes it simple to place on the face and comfortable to use. With the help of this accessory, the user avoids dryness and consequent irritations caused to the respiratory mucous membranes in dry environments. Additionally, the mask offers protection against the dissemination of toxic or infectious agents, an important function chiefly in co-existence with several people indoors. Furthermore, it is important to add that the masks in question can be made up of any filter screen, be it fabric, screens, films, provided that the material has small openings. In other words, these types of materials offer protection, since they substantially reduce the passage of infectious agents and other particles.

The utility model provides for the use of light and soft materials in making the mask, elastics adaptable to ears and mento, or directly on the head, with a coupled filter made of material that retains fluids, such as water, and which will be responsible for humidifying the air breathed in or inhaled. Such a filter can be combined into the disposable mask or coupled in the mode in which the mask can be reutilized. Such a mask features side movable openings or valves that open so that exhaled air is disposed of directly without passing through the humidifier filter, which could really remove the moisture, only necessary for air breathed in; and close when the user breathes out, allowing the elimination of expired CO₂, unnecessary and harmful to the body, also meaning the humidity inside the mask is not so high to the point of condensing water inside the mask, thus not requiring the use of an additional material to collect excess water droplets. Accordingly, it is clear that the improvements now proposed are a technological step forward in relation to the products currently offered on the market.

It is important to highlight that the material to be soaked can be any porous fabric (such as towels, gauze, or other type of porous material) that absorbs and retains water. The openings are preferably made of the same fabric as the mask, as long as they are movable to open and close (so it can be from the fabrics of the masks, latex or other materials, provided they are mobile).

The solution developed differs substantially from the state of the art because it is a practical, low-cost, disposable and versatile device, which features all the functions of a traditional face mask and that due to this simple and innovative arrangement, it dispenses with the use of more complex or uncomfortable equipment, such as the use of wet towels on the face, preventing dryness and irritations in the respiratory mucous membranes.

### DESCRIPTION OF ACCOMPANYING DRAWINGS

In order for this utility model to be fully understood and put into practice by any technician from this technology sector, it will be clearly, concisely and fully described, based on the accompanying drawings, which illustrate and support it, as listed below:

FIG. 1 represents the front view of the humidifier protection mask.

FIG. 2 represents the rear view of the humidifier protection mask.

FIG. 3 represents the right side view of the humidifier protection mask.

FIG. 4 represents an alternative front view of the humidifier protection mask, exemplifying the expiratory valve.

FIG. 5 represents the mask, from an upper point of view, with the humidifier filter removed for exchange and/or replenishment.

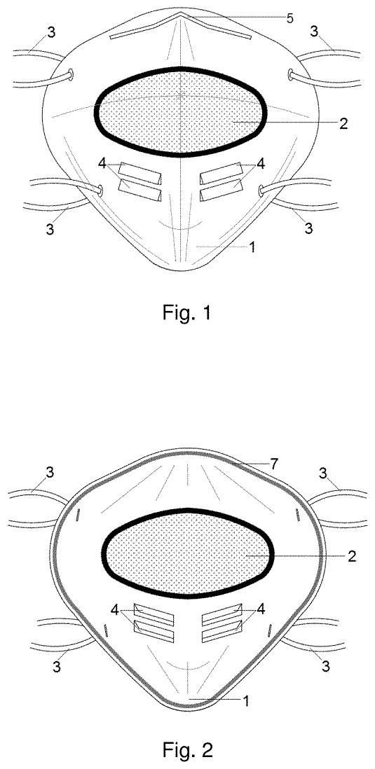

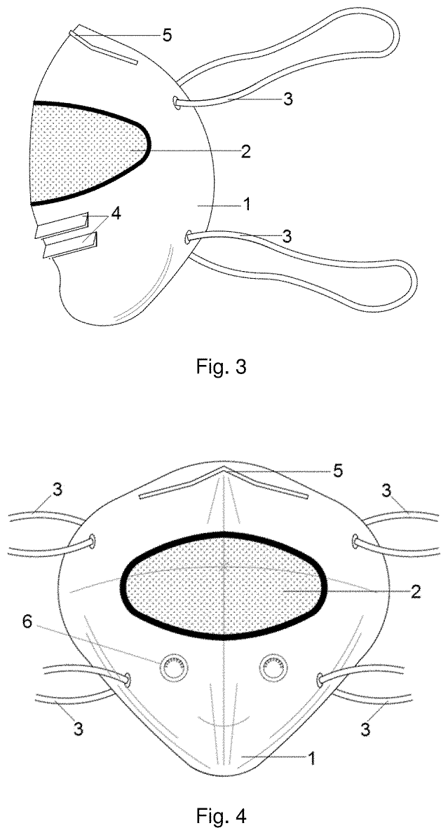

### DETAILED DESCRIPTION OF THE UTILITY MODEL

This utility model consists of a humidifier protection mask endowed with a filter to be soaked in water, which humidifies inhaled air and, additionally, promotes protection to the user against particles suspended in the air, such as dust, and has mobile openings to eliminate expired CO₂.

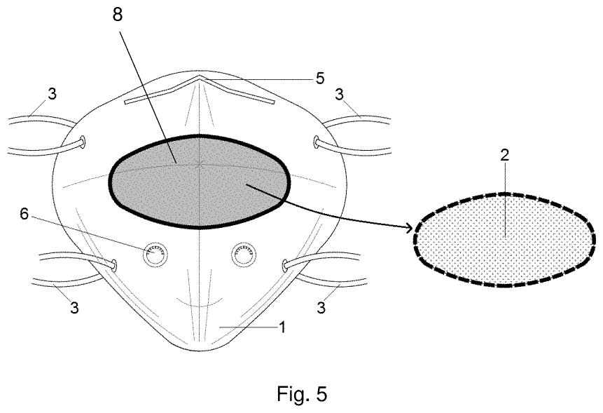

The proposed device consists of a shell-shaped base that anatomically couples to the face (1), a humidifier filter that absorbs and retains water (2), elastics or elastic bands (3) to encase the mask onto the face, movable side openings (4) and malleable strip (5) for nasal dorsum adjustment. The body of the mask can be disposable after use or else can be reused, discarding only the filter humidifier (2) according to the drawing represented in FIG. 5.

In short, the utility model is based on the search for a simple and practical accessory, which solves the discomforts related to environments with low relative humidity level of the air and/or coarse particles dispersed without causing discomfort by use for long periods.

Said shall-shaped base (1) supports the mask and anatomically covers the region of the face comprising the mouth and nose. The base (1) is made of waterproof material and prevents the passage of inhaled air, preferably waterproof fabric or synthetic materials, such as special plastics, rubbers, latex or silicone, so that it does not get wet in its entirety, but only in the central region where the humidifier filter is located (2), bringing comfort to the user and allowing easy replenishment. In this way, the user can replenish the humidifier filter easily, simply by watering it, and using the mask without it getting wet.

To promote adhesion to the skin and minimally avoid the inlet of air or contaminating agents, the base (1) can present a thin layer of adherent material along the entire edge (7). Such a layer should be composed of inert and non-irritating material for the skin, preferably silicone.

The material of the humidified filter (2) is made of material with high capacity for absorption and retention of water or other fluids, so that it can be soaked and retain them for a certain period, or be attachable with a replenisher, over or for part of the total period intended for use of the mask. Additionally, it should be antiallergic, preferably biodegradable and should allow water retention for at least 30 to 60 min. Whenever necessary, the user can replenish water, since the air is humidified due to evaporation of the water contained in the humidifier filter (2). This can consist of only one or even several layers, being preferably made of towel fabric or various layers of absorbent fabrics or specifically compacted cotton layers to suit that end.

Because it remains moist, the humidifier filter (2) may exhibit deterioration or contamination in the course of its use and, accordingly, it can be replaced in isolation, if the mask body is reusable. In an embodiment wherein the mask (1) is reusable, the replacement of the humidifier filter (2) is performed by fitting or coupling it in an internal pocket (8) of said mask. Said pocket (8) comprises the same arrangement as those known in the state of the art, that is, it is an element attached (by seam, glue or any other usual means of attachment) to the internal or external part of an object of personal use, with a slot at one end.

The mask also features at least two or more side mobile openings (4) that close when the individual breathes in and opens when the individual breathes out, made of light and mobile material or alternatively two valves (6), both open during exhalation and close during inhalation, represented in FIG. 4. The first alternative has a similar arrangement to a shutter, which causes its blades or fins to remain closed upon inhalation and opened upon exhalation. Such arrangement of the openings (4) presents the major benefit of expelling the air from user exhalation, which contains carbon dioxide (CO₂) which needs to be disposed of from inside the mask and prevents water present in the vapor from condensing and making the mask uncomfortable for the user to use. Said opening can be manufactured in various shapes, for example, but not limited to, windows, shutters, valves, fabrics, or any other arrangement that allows the outlet of exhaled air and prevents the intake of inhaled air, which should enter the mask only through the humidifier filter.

On the sides of the base (1) at least one clip is fastened on each side, made of elastic material (3), for fastening the mask on the user's face by way of the ears or directly on the head. A strip of malleable material (5) is located at the inner top of the mask and presents the function of adjusting the nasal dorsum, like other masks of the state of the art. The strip can be composed of any moldable material that adjusts to the nasal septum and may be a metal or polymer.

The mask can be elaborated in different dimensions and thus serve consumers of various ages and face shapes. Additionally, the water used to humidify the air inside the mask may comprise aromatic or therapeutic substances which promote and do not harm health in order to improve respiratory symptoms or mask bad smells present in the environment.

It is important to point out that the drawings and descriptions performed do not have the weight of limiting the mode of implementation of the inventive concept now proposed, but rather to illustrate and make understandable the conceptual innovations disclosed in this invention. In this way, the descriptions and images should be interpreted illustratively and non-limitingly, and there may be other equivalent or analogous ways of implementing the inventive concept now disclosed and that does not stray from the scope of protection delineated in this invention.

This specification refers to a new arrangement applied in a humidifier protection mask, endowed with novelty, descriptive sufficiency [full disclosure], inventive step, industrial application and consequently satisfying all the essential requirements for granting the privilege claimed.

1. An ARRANGEMENT APPLIED TO HUMIDIFIER AND PROTECTION MASK consisting of
a shell-shaped base (1), impregnated with a thin layer of cling material (7) across its edge, endowed with elastic loops (3) located on the sides of the base (1) and strip of malleable material (5) located at the outer upper part of the base (1)
a humidifier filter in the center of the base (1);
said mask being disposable or reusable with the humidifier filter (2) being; characterized in that said mask further contains movable openings (4) as outlets for expired air (6); wherein said mobile openings (4) close upon breathing in and open upon breathing out.

2. The ARRANGEMENT APPLIED TO HUMIDIFIER AND PROTECTION MASK according to claim 1, characterized in that the shell-shaped base or body (1) is made of impermeable tissue in the disposable mode or of washable or hygienizable material in the reusable mode; wherein said material of the reusable mode is plastic, latex or silicone.

3. The ARRANGEMENT APPLIED TO HUMIDIFIER AND PROTECTION MASK according to claim 1, characterized in that the humidifier filter (2) is made of material with high absorption and retention of water, preferably towel or other absorbent and porous fabrics or materials.

4. The ARRANGEMENT APPLIED TO HUMIDIFIER AND PROTECTION MASK according to claim 1, characterized in that the movable openings (4) are made of waterproof, light and movable material, which can be the same fabric as the body of the mask, or washable or hygienizable material in the reusable mode.

5. The ARRANGEMENT APPLIED TO HUMIDIFIER AND PROTECTION MASK according to claim 1, characterized in that the mobile openings (4) are valves (6).
